(19) United States
(12) Patent Application Publication
(10) Pub. No.: US 2010/0000485 A1
(43) Pub. Date: Jan. 7, 2010

(54) IGNITION DEVICE FOR AN INTERNAL COMBUSTION ENGINE

(76) Inventors: Manfred Vogel, Ditzingen (DE); Werner Herden, Gerlingen (DE); Heiko Ridderbusch, Schwleberdingen (DE); Bernd Ozygus, Berlin (DE)

Correspondence Address: KENYON & KENYON LLP, ONE BROADWAY, NEW YORK, NY, 10004, US

(21) Appl. No.: 11/921,211

(22) PCT Filed: Mar. 27, 2006
(86) PCT No.: PCT/EP2006/061049

§ 371 Date: Sep. 8, 2009

(30) Foreign Application Priority Data
May 27, 2005 (DE) 10 2005 024 482.3

(51) Int. Cl. F02P 23/04; H01S 3/11

(52) U.S. Cl. 123/143 B; 372/10; 372/40; 372/43.01; 372/50.22; 372/38.06

(57) ABSTRACT

An ignition device for an internal combustion engine includes at least one pump light source which supplies a pump light. In addition, a laser device is provided which generates a laser pulse for emission into a combustion chamber. A light guide device transmits the pump light from the pump light source to the laser device. Finally, a laser-active solid body, a passive Q-switch, an incoupling mirror, and an output mirror of the laser device are arranged as one integrated monolithic part.

### FIELD OF THE INVENTION

The present invention relates to an ignition device for an internal combustion engine.

### BACKGROUND INFORMATION

An ignition device of the generic type is discussed in WO 02/081904 in which a laser ignition device is situated on a cylinder of an internal combustion engine. The actual laser device is connected to a pump light source, which optically pumps the laser device, via a light guide device formed by a glass fiber.

### SUMMARY OF THE INVENTION

An object of the exemplary embodiments and/or exemplary methods of the present invention is to refine an ignition device of the type mentioned at the outset in such a way that it may be used in large quantities as cost-effectively as possible.

This object may be achieved by an ignition device having the features described herein. Advantageous refinements are also disclosed herein.

The monolithic part provided according to the exemplary embodiments and/or exemplary methods of the present invention is particularly resistant to the ambient conditions occurring in a motor vehicle having an internal combustion engine, for example, accelerations, low and high temperatures and high temperature gradients, without complex and expensive engineering measures for mounting the incoupling mirror and the output mirror, for example, being necessary. This already cuts manufacturing costs considerably.

In addition, the reliability in operating such an ignition device is increased since, despite the external influences, the individual elements cannot change their position relative to one another, which is important for operating the ignition device. Moreover, the assembly costs and assembly times are reduced because fewer separate parts must be handled.

Furthermore, such a monolithic part may be manufactured in an automated manner, which also cuts the manufacturing costs. This is particularly true when the different mirrors are simply manufactured using an appropriate coating of an end surface of the laser-active solid body and when the monolithic part is made of a wafer.

Additional cost savings may be achieved when the resonator of the laser device is formed not only by the laser-active solid body but, in addition, by a glass body. In this case, the relatively expensive laser-active solid body may be significantly smaller. A large variety of arrangements of the glass body relative to the laser-active solid body of the laser device and relative to the Q-switch are possible, depending on the individual assembly requirements. A reflecting device, e.g., in the form of a glass body, may be situated radially around the laser-active solid body in order to couple in pump light, which is beamed past the incoupling mirror by the light guide device, transversally into the laser-active solid body. This makes it possible to implement a very short ignition device which needs no particular incoupling optics, and yet operates with high efficiency.

Increasing efficiency is also possible by using an optical amplifier which may be supplied from a dedicated pump light source or from the pump light source of the laser device. The first variant allows higher performance to be implemented and the latter is particularly simple from the engineering point of view. This is particularly true when the optical amplifier and the laser device are monolithic. Here also, a monolithic unit may be formed from the laser device, the glass body, the reflecting device, and the optical amplifier, the reflecting device being able to provide at least one reflecting surface which reflects the pump light not only to the laser-active body of the laser device, but also to the amplifier. In this way, very compact and sturdy units are implementable which are also manufacturable automatically on a large scale. However, it is also possible that the pump light, supplied by a single pump light source, is split by a bifocal lens, on the one hand onto the laser device and, on the other hand, onto the optical amplifier.

Moreover, a cost reduction may also be achieved due to the monolithic design of the optical device through which the laser beam is coupled into the combustion chamber and focused there onto a certain point.

Exemplary embodiments of the present invention are explained in the following with reference to the appended drawings.

### BRIEF DESCRIPTION OF THE DRAWINGS

FIG. 1 shows a schematic representation of an internal combustion engine having an ignition device.

FIG. 2 shows a schematic representation of the ignition device of FIG. 1.

FIG. 3 shows an enlarged representation of an area from FIG. 2.

FIGS. 4 to 21 show different exemplary embodiments of the ignition device of FIG. 2.

FIG. 22 shows a front view of a convergent lens of the exemplary embodiment in FIG. 21.

### DETAILED DESCRIPTION

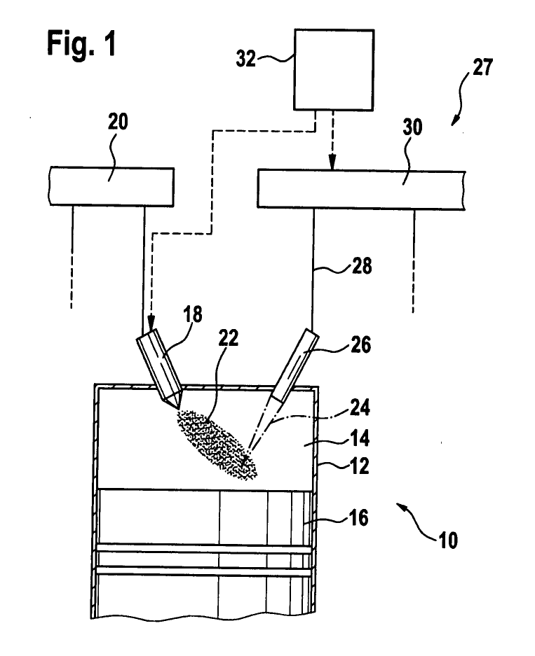

An internal combustion engine is indicated overall in FIG. 1 by reference numeral 10. It is used to drive a motor vehicle (not shown). Internal combustion engine 10 includes multiple cylinders of which only one is indicated in FIG. 1 by reference numeral 12. A combustion chamber 14 of cylinder 12 is delimited by a piston 16. Fuel is supplied to combustion chamber 14 through an injector 18 which is connected to a high-pressure fuel accumulator (“rail”) 20.

Fuel 22, injected into combustion chamber 14, is ignited via a laser pulse 24 which is emitted into combustion chamber 14 via an ignition device 27 including a laser device 26. For this purpose, laser device 26 is supplied with a pump light via a light guide device 28, the pump light being provided by a pump light source 30. Pump light source 30 is controlled by a control and regulator unit 32 which also activates injector 18.

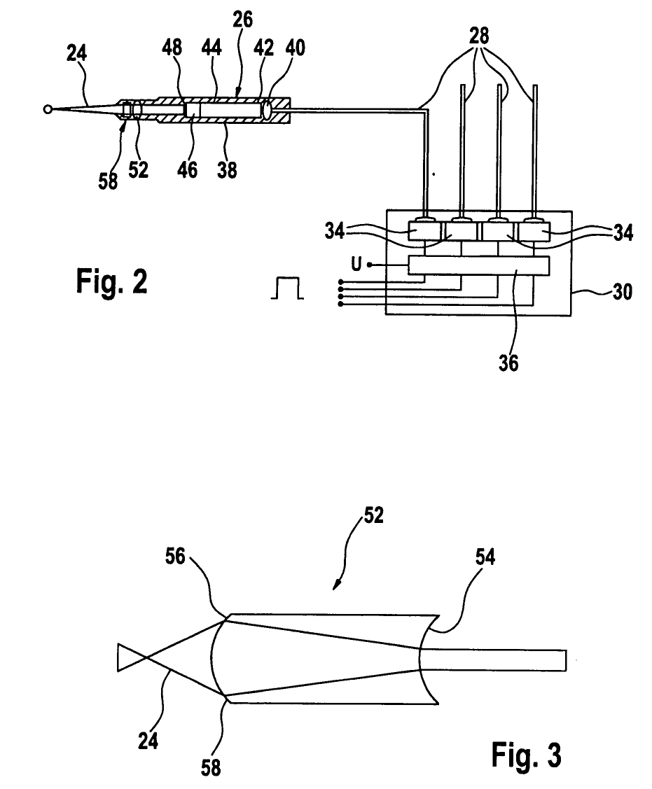

As is apparent from FIG. 2, pump light source 30 supplies multiple light guide devices 28 for different laser devices 26. For this purpose, the pump light source has multiple individual light sources 34 which are connected to a pulsating current supply 36.

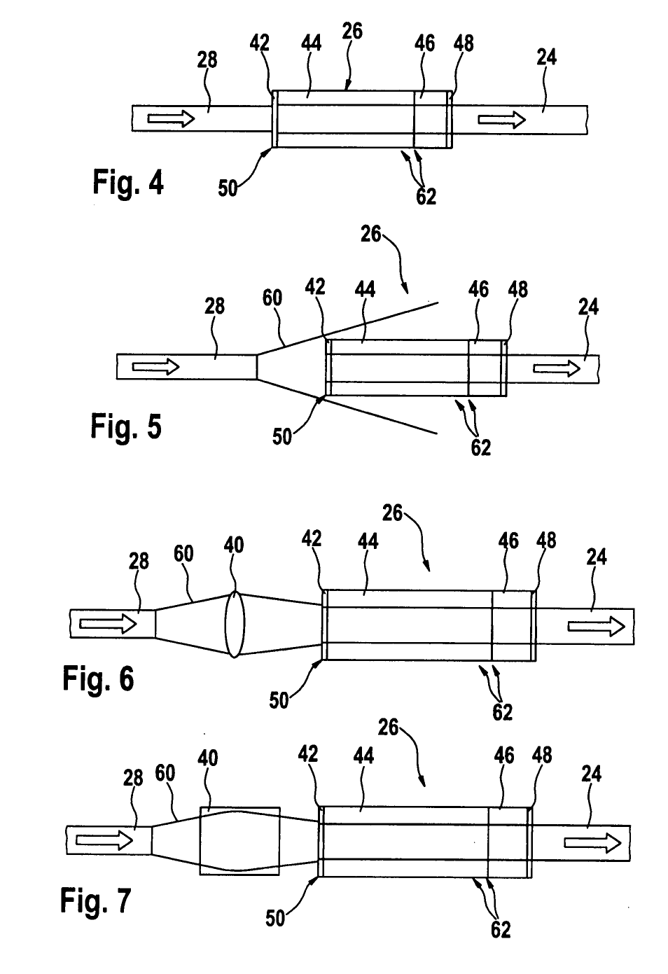

Laser device 26 includes a housing 38 in which, viewed in the pump light direction, first a lens 40, then an incoupling mirror 42, further a laser-active solid body 44, a passive Q-switch 46, and an output mirror 48 are situated (cf. FIGS. 4 through 7). Elements 42 through 48 are designed as one integrated monolithic part 50. In FIG. 2, left of output mirror 48 there is a focusing lens system 52 which, as FIG. 3 shows, is designed as a monolithic part having a concave inlet surface 54 for beam dispersion (divergent lens) and a convex exit surface 56 for focusing (convergent lens). Focusing lens system 52 may have an aspherical design. Furthermore, a combustion chamber window 58 is provided which, however, is designed as one piece together with focusing lens system 52.

Different basic embodiments of laser device 26 are explained based on FIGS. 4 through 7. For the sake of simplicity, the same reference numerals are used for elements and areas which have equivalent functions as elements and areas of previously described specific embodiments. The exemplary embodiment shown in FIG. 4 approximately corresponds to the system shown in FIG. 2 on a smaller scale. The system shown in FIG. 5 is quite similar; however, pump light 60 exiting light guide device 28 is slightly divergent and strikes incoupling mirror 42 in this way. In the system according to FIG. 6, the pump light is focused on laser-active solid body 44 through a convergent lens 60, and in the specific embodiment in FIG. 7, through a gradient index lens 40 on incoupling mirror 42. This makes it possible to set an optimum beam density of pump light 60 and less pump light 60 is lost. In addition, the optically critical border areas of laser-active solid body 44 need not be utilized.

The basic operating mode of laser device 26 is the following: Pump light 60 exits light guide device 28 and penetrates the rod-shaped laser-active solid body 44 through incoupling mirror 42 which is transparent for the wavelength of pump light 60. Pump light 60 is absorbed in the solid body which results in population inversion. Due to the high losses of passive Q-switch 46, laser oscillation is prevented. The beam density inside resonator 62 increases with increasing pumping time. At a certain beam density, passive Q-switch 46 fades, the gain exceeds the total losses in resonator 62, and the laser starts to oscillate.

In this way, a “giant pulse” 24 is created, i.e., a pulse with very high peak power. This is typically a few megawatts for a period of a few nanoseconds. A precondition for this is that incoupling mirror 42 is highly reflective for the wavelength of laser light 24; however, output mirror 48 is partly reflective for the wavelength of laser light 24, and passive Q-switch 46 has a certain starting transmission.

Laser devices 26, shown in FIGS. 4 through 7, are very easy to manufacture and are therefore particularly inexpensive. The connection between laser-active solid body 44 and Q-switch 46 may be established by wringing or thermal bonding. Incoupling mirror 42 and output mirror 48 are in turn manufactured by coating the axial end surfaces of laser-active solid body 44 and Q-switch 46.

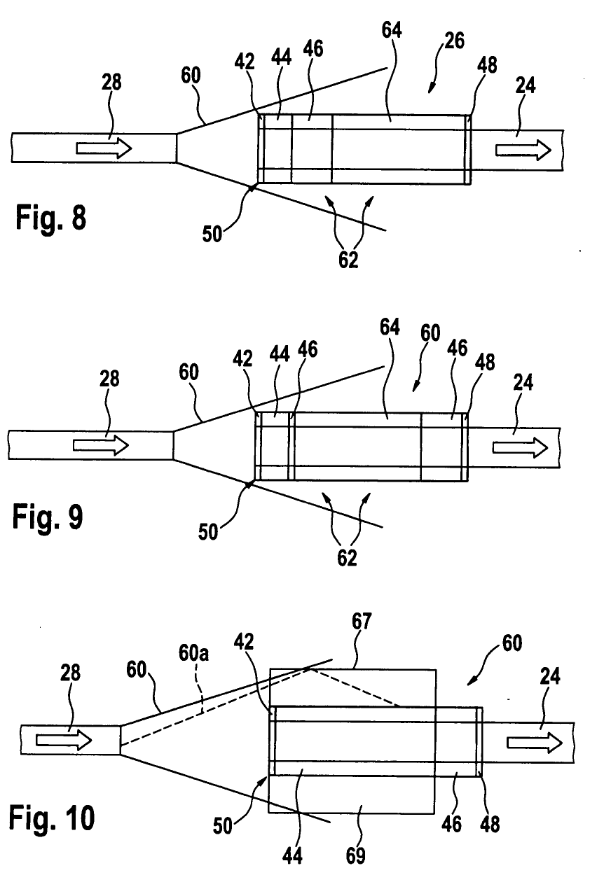

Another basic principle is shown in FIGS. 8 and 9: Resonator 62 of laser device 26 is formed there by a combination of laser-active solid body 44 and a glass body 64. This makes it possible to keep the length of laser-active solid body 44 comparatively short, thereby reducing manufacturing costs. A further substantial advantage is the fact that the beam quality of the laser device may be improved by using a longer resonator. Moreover, the pulse duration of the giant pulse may be controlled using the refractive index of the special glass and the length of the glass body. However, a precondition for this is that the pump light is completely absorbed in laser-active solid body 44 despite its shortness. In laser device 26, shown in FIG. 8, Q-switch 46 is situated between laser-active solid body 44 and glass body 64 and output mirror 48 is applied to the free axial end surface of glass body 64. In contrast, in laser device 26, shown in FIG. 9, glass body 64 is situated between the Q-switch and laser-active solid body 44 and output mirror 48 is applied to the axial end surface of Q-switch 46 as in the exemplary embodiments of FIGS. 4 through 7. A layer 66, highly reflective for pump light 60 but transparent for laser light 24, is additionally situated between laser-active solid body 44 and glass body 64 so that pump light 60, not yet absorbed over the axial length of laser-active solid body 44, is reflected back into it.

A lens is omitted in the embodiment according to FIG. 10. Instead, the pump light beamed past laser-active solid body 44 is beamed onto a reflecting device which is designed as a glass body 69 which encloses the laser-active solid body in the form of a sleeve. On reflecting surface 67, situated radially outside the glass body, which is optionally provided with a mirror layer, pump light 60, indicated by beam 60a for example, is reflected back to laser-active solid body 44 and transversally coupled into it. The mirror layer may be omitted mainly when glass body 69 has no radial outside optical contact with another medium. Otherwise, mirror layer 67 may be simply implemented via an adhesive material, using which glass body 69 is glued into another body. It is understood that glass body 69 or reflecting surface 67 may have not only a cylindrical outer contour, but also a conically tapered or curved outer contour.

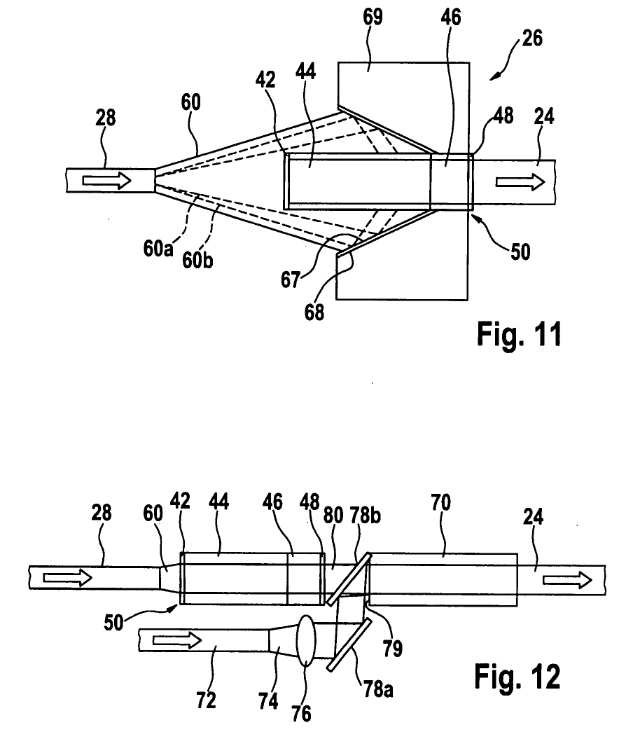

Also in the specific embodiment shown in FIG. 11, a reflecting device in the form of a glass body 69 is situated radially outside laser-active solid body 44. However, the radially inner limiting surface of the reflecting device is in contact with Q-switch 46 only in one area, while, in the area radially outside laser-active solid body 44, it is conically designed as reflecting surface 67 and provided with a mirror layer 68. Here also, pump light 60 (for example beams 60a and 60b), which cannot be coupled longitudinally into laser-active solid body 44 by incoupling mirror 42, is reflected and coupled transversally into laser-active solid body 44. The extractable energy of such a device is particularly high because a great volume of laser-active solid body 44 may be pumped. As an alternative, a metal body which is provided with a reflective, e.g., polished, reflecting surface could be used instead of glass body 69. It is also conceivable to fill the space between light guide device 28 and laser device 26 with a transparent casting compound.

In the devices shown in FIGS. 8 through 11, glass body 64 or 69 is fixedly connected to laser device 26 and is thus a component of monolithic part 50.

Other variants of a laser device 26 are again represented in FIGS. 12 through 21 in which an optical amplifier 70 is connected optically in series to laser device 28.

In FIG. 12, optical amplifier 70, which is essentially formed by a laser-active solid body, is situated coaxially to laser-active solid body 44 of laser device 26. Optical amplifier 70 has a dedicated pump light source (not shown) which supplies pump light 74 to optical amplifier 70 via a dedicated light guide device 72. Pump light 74 is coupled longitudinally into optical amplifier 70 by beaming the pump light through a lens 76 and two reflecting mirrors 78a and 78b onto front face 79 of optical amplifier 70 facing Q-switch 46. Mirror 78b, situated between laser-active solid body 44 of laser device 26 and optical amplifier 70, is highly reflective for the wave length of pump light 74 for amplifier 70, but is transparent for laser light 80 beamed from laser device 26 to amplifier 70.

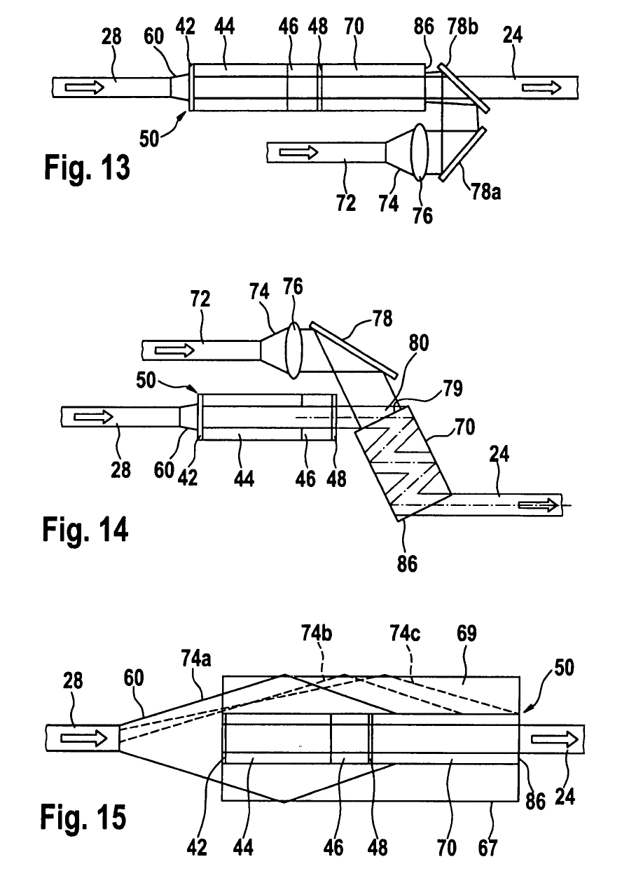

The specific embodiment represented in FIG. 13 operates similarly, laser device 26 and optical amplifier 70 being monolithic in this case. To achieve this, pump light 74 from light guide device 72 is pumped into optical amplifier 70 from the “backside,” i.e., on the face from which amplified laser beam 24 exits. This means that mirror 78b is highly reflective for pump light 74, but transparent for laser pulse 24.

FIG. 14 again shows a different specific embodiment in which a multiple passage of laser light 80 through optical amplifier 70 is implemented. Doping of optical amplifier 70 is advantageously selected in such a way that the energy of pump light 74 is completely absorbed only at the end of optical amplifier 70. Multiple passage of laser light 80 in optical amplifier 70 is achieved in that laser beam 80 does not hit axial end surface 79 of optical amplifier 70 perpendicularly, but rather obliquely. For this purpose, the longitudinal axis of optical amplifier 70 is tilted with respect to the longitudinal axis of laser-active solid body 44. An additional advantage of this arrangement is the fact that only a single reflecting mirror 78 is required for coupling pump light 74 into optical amplifier 70, and possibly no reflecting mirror at all is required.

Specific embodiments are shown in FIGS. 15 through 21 in which an optical amplifier 70 is present; an additional light guide device, however, may be omitted. The arrangement shown in FIG. 15 is similar to the one shown in FIG. 10. However, viewed in the direction of the optical axis, optical amplifier 70 is situated directly behind Q-switch 46 with output mirror 48. A sleeve-like reflecting device in the form of a glass body 69 again extends radially on the outside from laser-active solid body 44, from Q-switch 46, and also from optical amplifier 70.

The diameter of sleeve-like glass body 69 is selected in such a way that pump light 74a, 74b, and 74c, which exits light guide device 28 and is beamed past incoupling mirror 42 of laser-active solid body 44 of laser device 26, is reflected on radially outer reflecting surface 67 of sleeve-like glass body 69, which is optionally provided with a mirror layer, and coupled transversally into optical amplifier 70.

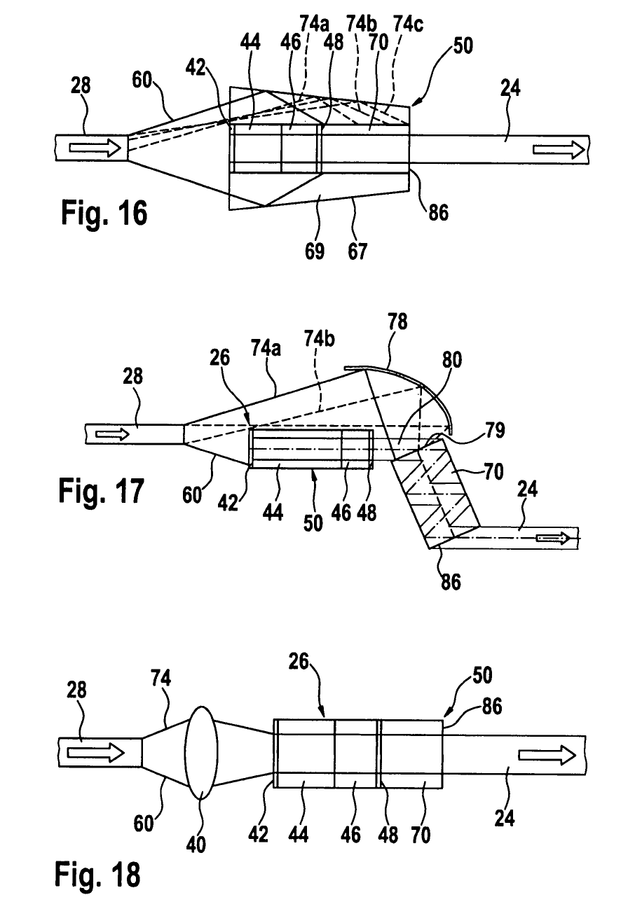

Laser device 26, optical amplifier 70, and glass body 69 together may be designed as a monolithic part. The device shown in FIG. 16 has a similar design; the configuration is shorter, however, since the radially outer peripheral surface of glass body 69 is conically tapered, viewed in the beam direction.

The device shown in FIG. 17 is again similar to the one shown in FIG. 14. However, laser device 26 is situated slightly offset with respect to the axis of light guide device 28. Moreover, mirror 78 is designed as a convergent mirror which focuses pump light beams 74, divergently exiting light guide device 28, onto axial inlet surface 79 of optical amplifier 70.

FIG. 18 shows a very simple arrangement in which optical amplifier 70 is situated directly downstream from Q-switch 46, i.e., output mirror 48 present thereon, and is supplied with pump light (without reference numeral) which passes from light guide device 28 through laser-active solid body 44, i.e., is not completely absorbed by it. This means that Q-switch 46 is transparent for the wavelength of the pump light for optical amplifier 70 and that output mirror 48 must also be transparent for the wavelength of the pump light for optical amplifier 70. In addition, the pump light beam for optical amplifier 70 should have a low divergence. Here also, amplifier 70 is part of monolith 50.

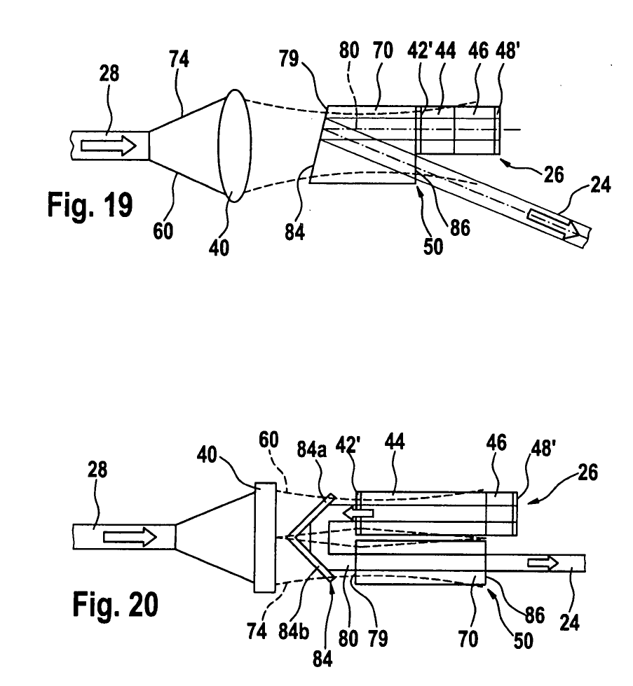

In the device shown in FIG. 19, pump light 74 for amplifier 70 reaches optical amplifier 70 directly from light guide device 28. Pump light 60 for laser-active solid body 44 of laser device 26 passes through optical amplifier 70 and only then reaches laser-active solid body 44. Mirrors 42′ and 48′ are designed accordingly. Axial end face 79 of optical amplifier 70, facing light guide device 28, has an oblique design and is provided with a mirror layer 84 which is transparent for pump light 60, 74 but reflective for the wavelength of laser beam 24. In this way, laser beam 80, beamed from laser-active solid body 44 into optical amplifier 70, is reflected obliquely and exits optical amplifier 70 obliquely as laser beam 24.

The system according to FIG. 20 has an even greater efficiency. Pump light 60 exiting from light guide device 28 is bundled by a bifocal Fresnel lens 40 and beamed in the form of two discrete beams through a mirror system 84 onto laser-active solid body 44 and optical amplifier 70 situated adjacent thereto. Laser-active solid body 44 of laser device 26 and laser-active solid body of optical amplifier 70 are designed as a one-piece monolithic part 50. Mirror system 84 includes two mirror surfaces 84a and 84b, situated at a right angle to one another, which are transparent for pump light 60 exiting light guide device 28 and reflective for laser light 80 exiting laser-active solid body 44 of laser device 26. In this way, laser beam 80 exiting backwards from laser device 26 is deflected to the side and back to optical amplifier 70.

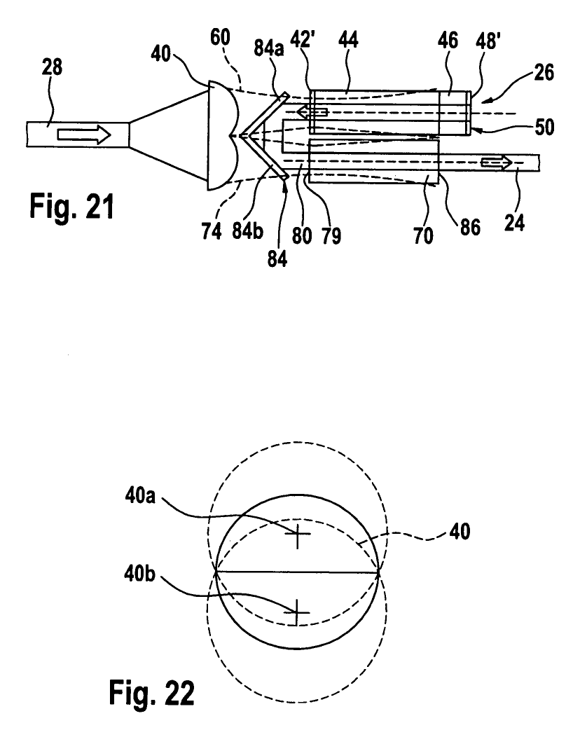

The system shown in FIG. 21 operates similarly, laser-active solid body 44 of laser device 26 and optical amplifier 70 being designed as separate components and pump light 60, 74 being generated by a non-rotation-symmetric bifocal convergent lens 40 according to FIG. 22 having two lens centers 40a and 40b. The device represented in FIG. 21 has the advantage, just as the one in FIG. 20, that only one light guide device 28 is required, laser device 26 and optical amplifier 70 are pumped longitudinally with an appropriate high efficiency, laser beam 24 exits axially, and the overall dimensions are relatively small.

It is understood that the device shown in FIGS. 12 through 21, in which a laser device 26 is coupled with an optical amplifier 70, may be combined with the specific embodiments shown in FIGS. 8 through 11 in which a glass body 64 is additionally provided. Moreover, even if not shown, an output surface of optical amplifier 70 (surface 86 in FIG. 20, for example) may be provided with a partially mirroring surface thereby creating a “coupled resonator.” In this way, a partial multiple passage through optical amplifier 70 is achieved.

1-24. (canceled)

25. An ignition device for an internal combustion engine of a motor vehicle, comprising:
at least one pump light source which provides a pump light;
a laser device to generate a laser pulse for emission into a combustion chamber;
a light guide device to transmit the pump light from the pump light source to the laser device; and
a laser-active solid body and a passive Q-switch, which are arranged as one monolithic part.

26. The ignition device of claim 25, wherein the laser-active solid body and the passive Q-switch are connected to one another by one of a wringing process, a thermal bonding process, and a sintering process.

27. The ignition device of claim 25, wherein the laser-active solid body and the passive Q-switch, and an incoupling mirror and an output mirror of the laser device, are arranged as one monolithic part, and wherein at least one of the incoupling mirror and the output mirror are produced by a dielectric coating.

28. The ignition device of claim 25, wherein the monolithic part is manufactured from a wafer.

29. The ignition device of claim 25, wherein a resonator of the laser device is formed by the laser-active solid body and at least one glass body.

30. The ignition device of claim 29, wherein the glass body is situated in series to the laser-active solid body and is longer than the laser-active solid body.

31. The ignition device of claim 29, wherein the glass body and the laser-active solid body are monolithic.

32. The ignition device of claim 29, wherein the glass body is situated between the passive Q-switch and the laser-active solid body, and a layer, which is highly reflective for the pump light and transparent for the laser light, is situated between the laser-active solid body and the glass body.

33. The ignition device of claim 25, wherein a reflecting device or a glass body is situated parallel to the laser-active solid body, enclosing the same radially on the outside, and the reflecting device has a reflecting surface from which the pump light is reflected transversally into the laser-active solid body.

34. The ignition device of claim 33, wherein the reflecting surface is oblique or conical.

35. The ignition device of claim 25, wherein it includes an optical amplifier into which pump light is coupled and which is situated in series to the laser device.

36. The ignition device of claim 35, wherein the laser device is supplied by a first light guide device and the amplifier is supplied by a second light guide device.

37. The ignition device of claim 35, wherein the laser device and the amplifier are supplied by the same light guide device.

38. The ignition device of claim 37, wherein the pump light is split to the laser device and the amplifier by a bifocal convergent lens system.

39. The ignition device of claim 35, wherein the amplifier is transversally supplied via reflection on a reflecting device or a reflecting surface of a glass body enclosing the amplifier.

40. The ignition device of claim 39, wherein the reflecting device is conically tapered when viewed in a beam direction.

41. The ignition device of claim 35, wherein the amplifier is longitudinally supplied via reflection on a reflecting device.

42. The ignition device of claim 35, wherein the passive Q-switch and the output mirror of the laser device are transparent for the wavelength of the amplifier pump light, the pump light is not completely absorbed by the laser-active solid body of the laser device, and the amplifier is situated on a side of the laser device facing away from the light guide device.

43. The ignition device of claim 35, wherein the amplifier is optically situated between the light guide device and the laser device, a reflector is optically situated downstream from the passive Q-switch, and the output mirror is situated between the amplifier and the laser-active solid body of the laser device, the area of the amplifier, into which the pump light is coupled, having an oblique design and the amplifier including a lateral output surface.

44. The ignition device of claim 35, wherein a reflector is optically situated downstream from the Q-switch and the output mirror is situated on a side of the laser-active solid body of the laser device facing away from the Q-switch, and the ignition device includes a deflection device which deflects the laser beam to the amplifier.

45. The ignition device of claim 44, wherein the amplifier and the laser-active solid body of the laser device are situated spatially side by side and are monolithic.

46. The ignition device of claim 35, wherein the output surface of the amplifier has a partially mirrored surface.

47. The ignition device of claim 25, further comprising:
a focusing lens system for the laser beam which includes a divergent lens and a convergent lens which are formed on a monolithic part.

48. The ignition device of claim 47, wherein the monolithic part includes a combustion chamber window.

49. The ignition device of claim 25, wherein the laser-active solid body and the passive Q-switch, and an incoupling mirror and an output mirror of the laser device, are arranged as one monolithic part.
